(19) United States
(12) Patent Application Publication
(10) Pub. No.: US 2013/0271703 A1
(43) Pub. Date: Oct. 17, 2013

(54) LIQUID CRYSTAL PANEL AND LIQUID CRYSTAL DISPLAY WITH THE SAME

(71) Applicant: Hsiao-hsien Chen, Shenzhen (CN)

(72) Inventor: Hsiao-hsien Chen, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/517,287

(22) PCT Filed: Apr. 23, 2012
(86) PCT No.: PCT/CN2012/074543

§ 371 Date: Jun. 20, 2012

(30) Foreign Application Priority Data
Apr. 16, 2012 (CN) 201210110989.2

(51) Int. Cl. G02F 1/1335

(52) U.S. Cl. 349/96

(57) ABSTRACT

A liquid crystal panel includes an array substrate, a first polarization plate disposed on an outer side of the array substrate, a second polarization plate, a liquid crystal sandwiched between the array substrate and the second polarization plate, and a color filter disposed on an outer side of the second polarization plate. The liquid crystal layer is disposed between the first transparent electrode layer and the second polarization plate, which guarantees a high contrast of the liquid crystal panel and avoids an increase of the manufacturing cost of the liquid crystal panel. Meanwhile, the thicknesses of the color resistances can be adjusted according to different requirements. Thus, the color saturation of the liquid crystal panel can be adjusted and color coordinates of the liquid crystal panel can also be broadened. The present disclosure further provides a liquid crystal display having the above liquid crystal panel.

### BACKGROUND

1. Technical Field

The present disclosure relates to liquid crystal displaying technologies, and particularly, to a liquid crystal panel and a liquid crystal display with the same.

2. Description of Related Art

The advent of liquid crystal display (LCD) has brought visual impacts and visual and sensual enjoyments to consumers. With the development of the LCD technologies, LCD of high definition has become the common target of the consumers and the manufacturers of the LCD.

Referring to FIG. 1, a conventional liquid crystal panel used in a thin film transistor liquid crystal display (TFT-LCD) 100, is shown. Generally, the liquid crystal panel 100 includes an array substrate 120, a color filter 140 opposite to the array substrate 120, a liquid crystal layer 130 disposed between the array substrate 120 and the color filter 140, a first polarization plate 110 disposed on one side of the array substrate 120 which is away from the liquid crystal layer 130, and a second polarization plate 150 disposed on one side of the color filter 140 which is away from the liquid crystal layer 130. Light emitted from the a light source (not shown) enters the liquid crystal panel 100, passes through the first polarization plate 110, the array substrate 120, the liquid crystal layer 130, the color filter 140, and the second polarization plate 150 in order, and then gives out of the liquid crystal panel 100.

Referring to FIG. 2a, the color filter 140 includes color resistances whose quality affect a contrast of the liquid crystal panel, while the quality of the color resistance is related to sizes of pigments forming the color resistant. Pigments of larger size may change the direction of the polarization light easily, thereby reducing the contrast of the liquid crystal panel. Therefore, the pigments are often miniaturized to improve the contrast of the liquid crystal panel. As shown in FIG. 2b, the miniaturized pigments do not affect the polarization light easily and further do not result in the reduction of the contrast of the liquid crystal panel. However, the color filter should be processed sophisticatedly to miniaturize the pigments, which increases the manufacturing cost of the color filter and further increases the manufacturing cost of the liquid crystal panel. Additionally, since the liquid crystal layer is sealed between the array substrate and the color filter, thicknesses of the color resistances of the color filter cannot be differentiated from each other greatly for ensuring the height of the liquid crystal layer. However, this may limit the color saturation of the liquid crystal panel.

Therefore, there is room for improvement in the art.

### SUMMARY

One object of the present disclosure is to provide a liquid crystal panel. The liquid crystal panel includes an array substrate, a first polarization plate disposed on an outer side of the array substrate, a second polarization plate, a liquid crystal sandwiched between the array substrate and the second polarization plate, and a color filter disposed on an outer side of the second polarization plate. The color filter includes a second substrate and a color filter layer; the color filter layer is disposed on the second substrate and is sandwiched between the second polarization plate and the second substrate.

Preferably, the array substrate includes a first substrate, a thin transistor array layer formed on one side of the first substrate, and a first transparent electrode layer located on the thin film transistor array substrate, and the liquid crystal layer is disposed between the first transparent electrode layer and the second polarization plate.

Preferably, the liquid crystal panel further includes a second transparent electrode layer, and the liquid crystal layer is sandwiched between the first transparent electrode layer and the second transparent electrode layer.

Preferably, the second transparent electrode layer is disposed on the second polarization plate, and the second transparent electrode layer and the color filter are respectively disposed on opposite sides of the second polarization plate.

Preferably, the color filter is formed by a low temperature process or a printing process.

Preferably, an outer surface of the second substrate is a rough surface.

The present disclosure further provides another liquid crystal panel. The liquid crystal panel includes an array substrate, a first polarization plate disposed on an outer side of the array substrate, a liquid crystal layer disposed between the array substrate and second polarization plate, and a color filter disposed on an outer side of the second polarization plate.

Preferably, the array substrate includes a first substrate, a thin film transistor array layer formed on one side of the first substrate, and a first transparent electrode layer located on the thin film transistor array layer, and the liquid crystal layer is sandwiched between the first transparent electrode layer and the second polarization plate.

Preferably, the liquid crystal panel further includes a second transparent electrode layer, and the liquid crystal layer is sandwiched between the first transparent electrode layer and the second transparent electrode layer.

Preferably, the second transparent electrode layer is disposed on the second polarization plate, and the second transparent electrode layer and the color filter are respectively disposed on opposite sides of the second polarization plate.

Preferably, the color filter is formed by a low temperature process or by a printing process.

Preferably, the color filter includes a second substrate with an outer surface thereof being nebulized.

Preferably, the color filter includes a second substrate with an outer surface thereof being processed by particles coating process.

The present disclosure further provides a liquid crystal display. The liquid crystal display includes a liquid crystal panel and a backlight module assembled with the liquid crystal panel. The liquid crystal panel includes an array substrate, a first polarization plate disposed on an outer side of the array substrate, a liquid crystal layer disposed between the array substrate and second polarization plate, and a color filter disposed on an outer side of the second polarization plate. Light emitted from the backlight module gives out of the liquid crystal panel after transmitting through the liquid crystal panel.

Preferably, the array substrate includes a first substrate, a thin film transistor array layer formed on one side of the first substrate, and a first transparent electrode layer located on the thin film transistor array layer, and the liquid crystal layer is sandwiched between the first transparent electrode layer and the second polarization plate.

Preferably, the liquid crystal panel further includes a second transparent electrode layer, and the liquid crystal layer is sandwiched between the first transparent electrode layer and the second transparent electrode layer.

Preferably, the second transparent electrode layer is disposed on the second polarization plate, and the second transparent electrode layer and the color filter are respectively disposed on opposite sides of the second polarization plate.

Preferably, the color filter includes a second substrate and a second color filter layer formed on the second substrate, and the color filter layer is located between the second polarization plate and the second substrate.

Preferably, the color filter is formed by a low temperature process or a printing process.

Preferably, an outer surface of the second substrate is substantially rough.

In the liquid crystal panel of the present disclosure, the liquid crystal layer is disposed between the first transparent electrode layer and the second polarization plate. Therefore, sizes of pigments of the color filter are irrelevant to the light contrast, which guarantees a high contrast of the liquid crystal panel and avoids an increase of the manufacturing cost of the liquid crystal panel. Meanwhile, thicknesses of color resistances of the color filter no longer affect the spacers of the liquid crystal layer. Therefore, the thicknesses of the color resistances can be adjusted according to different requirements. In this way, the color saturation of the liquid crystal panel can be adjusted and color coordinates of the liquid crystal panel can also be broadened, which allow the liquid crystal panel to meet requirements of different color standards. The liquid crystal display having the above liquid crystal panel is provided with a higher contrast, a broader color gamut, a broader viewing angle, and an unlimited color saturation without increasing the manufacturing cost thereof.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view of a conventional liquid crystal panel.

FIG. 2a is a schematic view of a transmission path of a polarization light through a color filter having relatively larger pigments.

FIG. 2b is a schematic view of a transmission path of the polarization light through a color filter having the miniaturized pigments.

FIG. 3 is a schematic view of a liquid crystal panel in accordance with a first embodiment of the present disclosure.

FIG. 4 is a schematic view showing light transmitting through the liquid crystal panel of FIG. 3.

FIG. 5 is a schematic view of a liquid crystal panel in accordance with a second embodiment of the present disclosure.

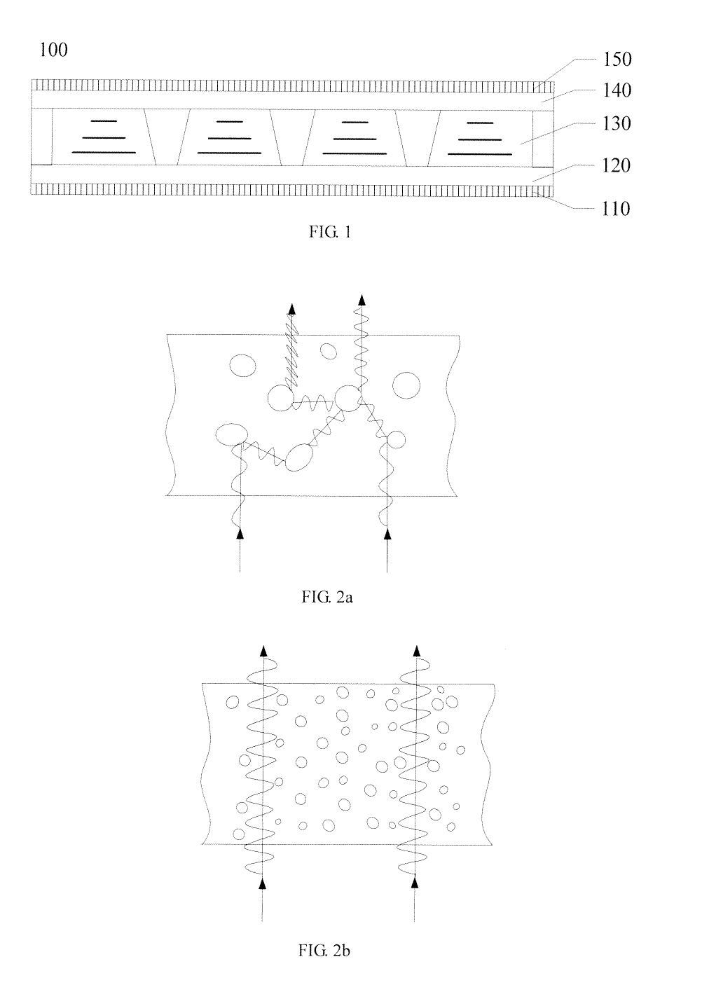

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

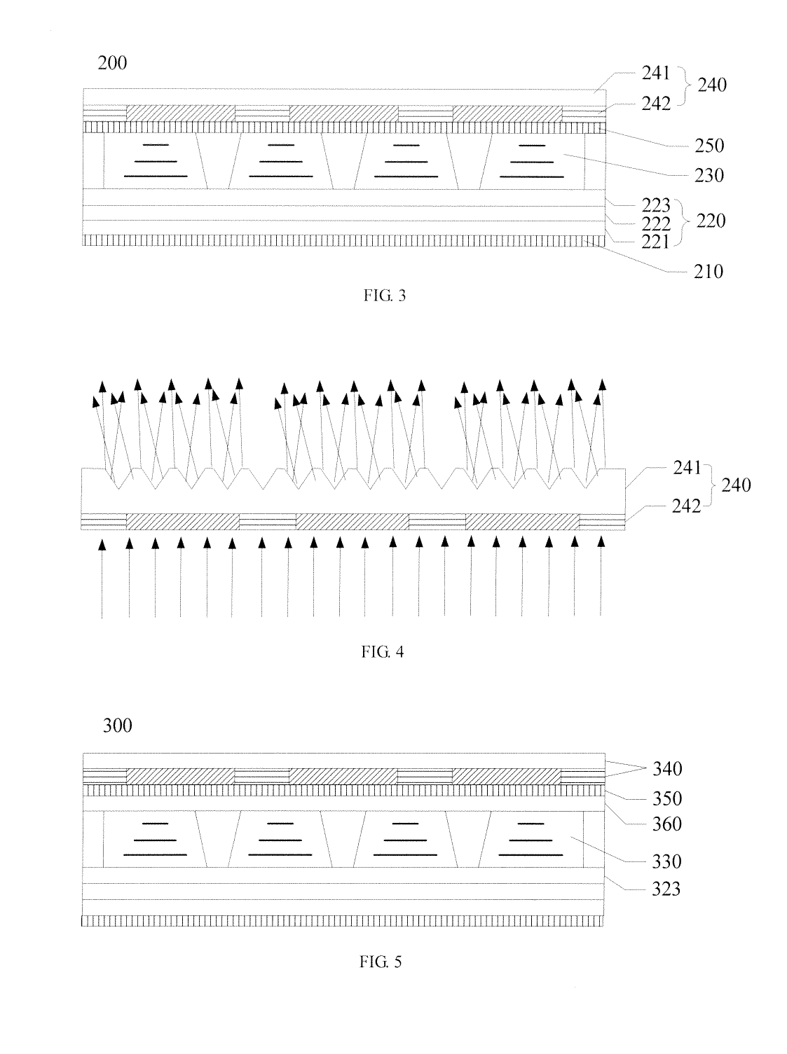

Referring to FIG. 3, a liquid crystal panel 200 in accordance with a first embodiment is shown. The liquid crystal panel 200 includes a first polarization plate 210, an array substrate 220, a liquid crystal layer 230, a color filter 240, and a second polarization plate 250. The liquid crystal layer 230 is disposed between the array substrate 220 and the second polarization plate 250. The first polarization plate 210 is disposed on an outer side of the array substrate 220 which is away from the liquid crystal layer 230. The color filter 250 is disposed on an outer side of the second polarization plate 250 which is away from the liquid crystal layer 230. The color filter 240 includes a second substrate 241 and a color filter layer 242. The color filter layer 242 is formed on the second substrate 241 and is sandwiched between the second polarization plate 250 and the second substrate 241.

The array substrate 220 includes a first substrate 221, a thin film transistor (TFT) array layer 222 disposed on one side of the first substrate 221, and a first transparent electrode layer 223 located on the TFT array layer 222. The liquid crystal layer 230 is disposed between the first transparent electrode layer 223 and the second polarization plate 250.

In the liquid crystal panel 200 of the present disclosure, the liquid crystal layer 230 is disposed between the first transparent electrode layer 223 and the second polarization plate 250, and the color filter 240 is disposed on the outer side of the second polarization plate 250 which is away from the liquid crystal layer 230. Therefore, sizes of pigments of the color filter 240 are irrelevant to a contrast of the light, which guarantees a high contrast of the liquid crystal panel 200 and avoids an increase of the manufacturing cost of the liquid crystal panel 200. Meanwhile, thicknesses of color resistances of the color filter 240 no longer affect the spacers of the liquid crystal layer 230. Therefore, the thicknesses of the color resistances can be adjusted according to different requirements. In this way, the color saturation of the liquid crystal panel can be adjusted and color coordinates of the liquid crystal panel 200 can also be broadened, which allow the liquid crystal panel 200 to meet requirements of different color standards.

Referring to FIG. 4, an outer surface of the second substrate 241 of the color filter 240 is a rough surface. The outer surface of the second substrate 241 can be processed to be rough using a nebulization process or a particle coating process. Thus, the light entering onto the outer surface of the second substrate 241 can be scattered to a wide light distribution angle, which allows people to receive the light scattered therefrom in various angles. In this way, the viewing angle of the liquid crystal panel 200 can be increased.

After the liquid crystal panel 200 is assembled with a light source, the light emitted from the light source transmits through the first polarization plate 210, an array substrate 220, a liquid crystal layer 230, a second polarization plate 250, and the color filter 240 in order, and then gives out of the liquid crystal panel 200. Since the light enters to the color filter 240 after transmitting through the second polarization plate 250, therefore, the pigments of the color filter 240 do not influence the light contrast, which guarantees a high contrast of the liquid crystal panel 200. Meanwhile, the contrast of the liquid crystal panel 200 can be improved without changing the structure of the color filter 240, thereby avoiding sophisticate processing of the color filter 240 and further avoiding the increase of the manufacturing cost thereof. Additionally, since the liquid crystal layer 230 is disposed between the second polarization plate and the array substrate 220, a spacer of the liquid crystal layer 230 can be prevented from being influenced by the thickness of different parts of the color filter layer 242. In some situations where a wide color gamut is required, the thickness of the different parts of the color filter layer 242 can be adjusted for adjustment of the color saturation and broadening of the color coordinates. In this way, the liquid crystal panel 200 may meet different color standards requirements including but not limited to NTSC (National Television Standards Committee), SRGB (Standard RGB), and Adobe RGB, Photoshop.

In some embodiments, the color filter 240 can be disposed on the second polarization plate 250 after the liquid crystal layer 230 is sealed between the array substrate 220 and the second polarization plate 250. The color filter 240 can be formed using a low temperature process or a printing process. Thus, the color filter 240 can be used in various productions including but not limited to OLED (organic light-emitting diode) display.

Referring to FIG. 5, a liquid crystal panel 300, in accordance with a second embodiment, is shown. The liquid crystal panel 300 of the second embodiment is similar to the liquid crystal panel 200 of the first embodiment, and the difference between the liquid crystal panel 200 and the liquid crystal panel 300 lies in that, the liquid crystal panel 300 further includes a second transparent electrode layer 360. The second transparent electrode layer 360 is disposed on an inner side of the second polarization plate 350 and is sandwiched between the second polarization plate 360 and the liquid crystal layer 330. The color filter 340 is also disposed on the second polarization plate 350 and is opposite to the second transparent electrode layer 360. The liquid crystal layer 330 is formed between the first transparent electrode layer 323 and the second transparent electrode layer 360.

In the liquid crystal panel 300 of the present disclosure, the liquid crystal layer 330 is disposed between the first transparent electrode layer 323 and the second transparent electrode layer 360, and the color filter 340 is disposed on the outer side of the second polarization plate 350 which is away from the liquid crystal layer 330. Therefore, sizes of pigments of the color filter 340 are irrelevant to the light contrast, which guarantees a high contrast of the liquid crystal panel 300 and avoids an increase of the manufacturing cost of the liquid crystal panel 300. Meanwhile, thicknesses of color resistances of the color filter 340 no longer affect the spacers of the liquid crystal layer 330. Therefore, the thicknesses of the color resistances can be adjusted according to different requirements. In this way, the color saturation of the liquid crystal panel can be adjusted and color coordinates of the liquid crystal panel 300 can also be broadened, which allow the liquid crystal panel to meet requirements of different color standards.

The present disclosure further provides a liquid crystal display. The liquid crystal display includes a backlight module and a liquid crystal panel assembled with the backlight module. The liquid crystal panel includes a first polarization plate, an array substrate, a liquid crystal layer, a second polarization plate, and a color filter. The liquid crystal layer is sandwiched between the array substrate and the second polarization plate. The first polarization plate is disposed on an outer side of the array substrate which is away from the liquid crystal layer. The second polarization plate is disposed on an outer side of the second polarization plate opposite to the liquid crystal layer. The light emitted from the backlight module gives out of the liquid crystal panel after transmitting through the first polarization plate, the array substrate, the liquid crystal layer, the second polarization plate, and the color filter in order.

It is noted that the liquid crystal panel can be the liquid crystal panel 200 of the first embodiment or the liquid crystal panel 300 of the second embodiment. With the liquid crystal panel, the liquid crystal display of the present disclosure is provided with a higher contrast, a broader color gamut, a broader viewing angle, and an unlimited color saturation without increasing the manufacturing cost thereof.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A liquid crystal panel, comprising:
an array substrate;
a first polarization plate disposed on an outer side of the array substrate;
a second polarization plate;
a liquid crystal layer sandwiched between the array substrate and the second polarization plate; and
a color filter disposed on an outer side of the second polarization plate, the color filter comprising a second substrate and a color filter layer, the color filter layer being disposed on the second substrate and being sandwiched between the second polarization plate and the second substrate.

2. The liquid crystal panel as claimed in claim 1, wherein the array substrate comprises a first substrate, a thin transistor array layer formed on one side of the first substrate, and a first transparent electrode layer located on the thin film transistor array substrate, and the liquid crystal layer is disposed between the first transparent electrode layer and the second polarization plate.

3. The liquid crystal panel as claimed in claim 2, wherein the liquid crystal panel further comprises a second transparent electrode layer, and the liquid crystal layer is sandwiched between the first transparent electrode layer and the second transparent electrode layer.

4. The liquid crystal panel as claimed in claim 3, wherein the second transparent electrode layer is disposed on the second polarization plate, and the second transparent electrode layer and the color filter are respectively disposed on opposite sides of the second polarization plate.

5. The liquid crystal panel as claimed in claim 4, wherein the color filter is formed by a low temperature process or by a printing process.

6. The liquid crystal panel as claimed in claim 4, wherein an outer surface of the second substrate is a rough surface.

7. A liquid crystal panel, comprising:
an array substrate;
a first polarization plate disposed on an outer side of the array substrate;
a liquid crystal layer disposed between the array substrate and second polarization plate; and
a color filter disposed on an outer side of the second polarization plate.

8. The liquid crystal panel as claimed in claim 7, wherein the array substrate comprises a first substrate, a thin film transistor array layer formed on one side of the first substrate, and a first transparent electrode layer located on the thin film transistor array layer, and the liquid crystal layer is sandwiched between the first transparent electrode layer and the second polarization plate.

9. The liquid crystal panel as claimed in claim 8, wherein the liquid crystal panel further comprises a second transparent electrode layer, and the liquid crystal layer is sandwiched between the first transparent electrode layer and the second transparent electrode layer.

10. The liquid crystal panel as claimed in claim 9, wherein the second transparent electrode layer is disposed on the second polarization plate, and the second transparent electrode layer and the color filter are respectively disposed on opposite sides of the second polarization plate.

11. The liquid crystal panel as claimed in claim 10, wherein the color filter is formed by a low temperature process or by a printing process.

12. The liquid crystal panel as claimed in claim 11, wherein the color filter comprises a second substrate with an outer surface thereof being nebulized.

13. The liquid crystal panel as claimed in claim 11, wherein the color filter comprises a second substrate with an outer surface thereof being processed by particles coating process.

14. A liquid crystal display, comprising:
a liquid crystal panel, comprising:
an array substrate;
a first polarization plate disposed on an outer side of the array substrate;
a liquid crystal layer disposed between the array substrate and second polarization plate; and
a color filter disposed on an outer side of the second polarization plate; and
a backlight module assembled with the liquid crystal panel, light emitted from the backlight module giving out of the liquid crystal panel after transmitting through the liquid crystal panel.

15. The liquid crystal display as claimed in claim 14, wherein the array substrate comprises a first substrate, a thin film transistor array layer formed on one side of the first substrate, and a first transparent electrode layer located on the thin film transistor array layer, and the liquid crystal layer is sandwiched between the first transparent electrode layer and the second polarization plate.

16. The liquid crystal display as claimed in claim 15, wherein the liquid crystal panel further comprises a second transparent electrode layer, and the liquid crystal layer is sandwiched between the first transparent electrode layer and the second transparent electrode layer.

17. The liquid crystal display as claimed in claim 16, wherein the second transparent electrode layer is disposed on the second polarization plate, and the second transparent electrode layer and the color filter are respectively disposed on opposite sides of the second polarization plate.

18. The liquid crystal display as claimed in claim 17, wherein the color filter comprises a second substrate and a second color filter layer formed on the second substrate, and the color filter layer is located between the second polarization plate and the second substrate.

19. The liquid crystal display as claimed in claim 18, wherein the color filter is formed by a low temperature process or by a printing process.

20. The liquid crystal display as claimed in claim 18, wherein an outer surface of the second substrate is substantially rough.
